(19) United States
(12) Patent Application Publication
(10) Pub. No.: US 2009/0010246 A1
(43) Pub. Date: Jan. 8, 2009

(54) Cordless telephone systems

(76) Inventors: Alan W. Grattan, Santa Cruz, CA (US); Helder R. Carvalheira, Scotts Valley, CA (US); Joyce R. Shimizu, Aptos, CA (US); Jay Wilson, Portola Valley, CA (US); Beatrice Casanova, San Jose, CA (US)

Correspondence Address: PLANTRONICS, INC.;IP Department/Legal, 345 ENCINAL STREET, P.O. BOX 635, SANTA CRUZ, CA, 95060-0635, US

(21) Appl. No.: 11/637,358

(22) Filed: Dec. 11, 2006

(51) Int. Cl. H04L 12/66

(52) U.S. Cl. 370/352; 455/556.1; 379/430

(57) ABSTRACT

A multimode home telephone system includes a computer, a base unit, a wireless handset and a wireless headset. The computer is programmed with a “soft phone” program to make and receive VOIP calls via the Internet and couple them to and from the base through a USB connection. The base is also coupled to a public switched telephone network (PSTN) and is operable to effect full duplex communication via both the PSTN and the Internet. The base, in turn, is wirelessly coupled to the handset via the DECT/UPCS protocol, and the handset is wirelessly coupled to the headset via the Bluetooth protocol, such that the user can selectively place and receive telephone calls via any one of the Internet, the PSTN or an optional Bluetooth enabled cell phone. Optionally, a DECT/UPCS enabled headset can communicate directly with the base in addition to or in lieu of the Bluetooth enabled headset.

### BACKGROUND

This disclosure relates to cordless telephone and wireless headset systems, in general, and in particular, to a reliable yet inexpensive, “hands-free” capable multimode cordless telephone apparatus and system for use in the home.

Recent advances in telecommunications hardware, software and protocols have enabled the provision of hands-free telecommunication freedom in the home by means of a variety of commonly used devices. Thus, cellular telephones (cell phones), cordless and wired phones coupled to a Public Switched Telephone Network (PSTN), Voice Over Internet Protocol (“VOIP”), and the Internet all coexist independently in the prior art. However, there are no affordable, “user friendly” systems available to the home user that enable these disparate communication channels to be used with each other in a relatively integrated and seamless fashion.

Accordingly, what is needed is a simple, relatively inexpensive integrated wireless system, including a headset, that enables a home user to selectively communicate seamlessly and transparently via all of the foregoing channels.

### BRIEF SUMMARY

In accordance with the exemplary embodiments thereof described herein, the present invention provides a home telephony system that includes a wireless, e.g., Bluetooth (BT) enabled, headset that communicates with a base station through a cordless handset that can also double as a speakerphone. A VOIP element is included in the system to increase its functionality, and conventional cell phone connectivity is also enabled. Thus, the user can selectively connect to three different telecommunication sources, viz., a conventional two-wire, PSTN, a conventional cell phone having Bluetooth headset connectivity, and Internet telephony via a personal computer (PC), the Internet and a VOIP communication protocol, such as Skype™, Windows Live™ or Vonage™. Additionally, the user interface provided by the novel system is more akin to the more familiar cellular phone interface than to a conventional cordless telephone interface.

In one exemplary embodiment, the multi-mode home telephone system comprises a personal computer (PC) having first and second communication ports. The first port is coupled to the Internet and the PC is programmed to implement a first voice communication protocol, e.g., the VOIP protocol, and is operable to effect full duplex voice communication via the Internet through the first port. The second port implements a second communication protocol, e.g., the USB protocol, and is operable to transmit and receive communication signals to and from the PC.

The system also includes a base unit having a first port coupled to a PSTN, and is operable to effect full duplex telecommunication via the PSTN through the first port, a second port coupled to the PC via the second port of the PC and operable to effect full duplex communication between and the base and the PC therethrough, and an RF transceiver implementing a third communication protocol, e.g., the Digital Enhanced Cordless Telecommunications/Unlicensed Personal Communications Service (DECT/UPCS) protocol, and operable to receive and transmit communication signals wirelessly to and from the base.

The system further includes a wireless handset incorporating first and second RF transceivers. The first transceiver implements the third communication protocol of the base, e.g., the DECT/UPCS protocol, and is operable to transmit and receive communication signals wirelessly between the handset and the base. The second RF transceiver implements a fourth communication protocol, e.g., the Bluetooth protocol, and is operable to transmit communication signals wirelessly to and from the handset.

The exemplary system further comprises a wireless headset having an RF transceiver implementing the fourth communication protocol of the handset, e.g., the Bluetooth protocol, and is operable to transmit communication signals wirelessly between the headset and the handset.

In another exemplary embodiment, the handset and the headset of the system are powered by respective rechargeable batteries, and the base further comprises battery charging receptacles, each of which is adapted to receive and recharge the respective battery of a respective one of the handset and the headset when disposed therein.

In another embodiment, the handset and headset may each further comprise firmware supporting an enhanced synchronous communications oriented (eSCO) protocol for wireless communication with the headset.

In another embodiment, the PC includes software operable to provide “soft phone” functionalities, including ringing, on hook and off hook functions. The base may further include a pair of push buttons, each of which is operable, when actuated, to cause a respective one of the handset and the headset to emit an audible locating signal.

The handset may advantageously further comprise a speakerphone, e.g., a half-duplex speakerphone, and may further include a jack for a corded headset, and the system may further include a corded headset that plugs into the jack in lieu of or in addition to the wireless headset.

The handset preferably comprises a dial pad having a plurality of buttons and a liquid crystal display (LCD) panel.

The wireless headset preferably comprises a microphone boom incorporating a noise cancelling (NC) microphone therein.

In another embodiment, the system may further comprise an optional Bluetooth enabled cell phone, and the headset may further comprise software and a call select button that enables the headset to select between the cell phone and the handset to place or answer a telephone call therewith.

In another embodiment, the system may further include a second headset having an RF transceiver implementing the third communication protocol, e.g., the DECT/UPCS protocol, which is operable to transmit communication signals wirelessly directly between the second headset and the base.

A better understanding of the above and many other features and advantages of the novel multimode home telephone system of the present invention may be obtained from a consideration of the detailed description of some exemplary embodiments thereof below, particularly if such consideration is made in conjunction with the appended drawings, wherein like reference numerals are used to identify like elements illustrated in one or more of the figures thereof.

### BRIEF DESCRIPTION OF THE DRAWINGS

FIG. 1 is a functional block diagram of an exemplary embodiment of a multimode home telephone system in accordance with the present invention;

FIG. 2 is another functional block diagram of the exemplary telephone system, showing signal flow of the system;

FIG. 3 is a functional block diagram of an exemplary alternative embodiment of a multimode home telephone system in accordance with the present invention;

FIG. 4 is an upper right side perspective view of a base component of the exemplary telephone system;

FIG. 5 is an upper right side perspective view of a handset component of the exemplary system;

FIG. 6 is an upper right side perspective view of a headset component of the system; and,

FIG. 7 is an upper left side perspective view of an optional cell phone component of the system.

### DETAILED DESCRIPTION

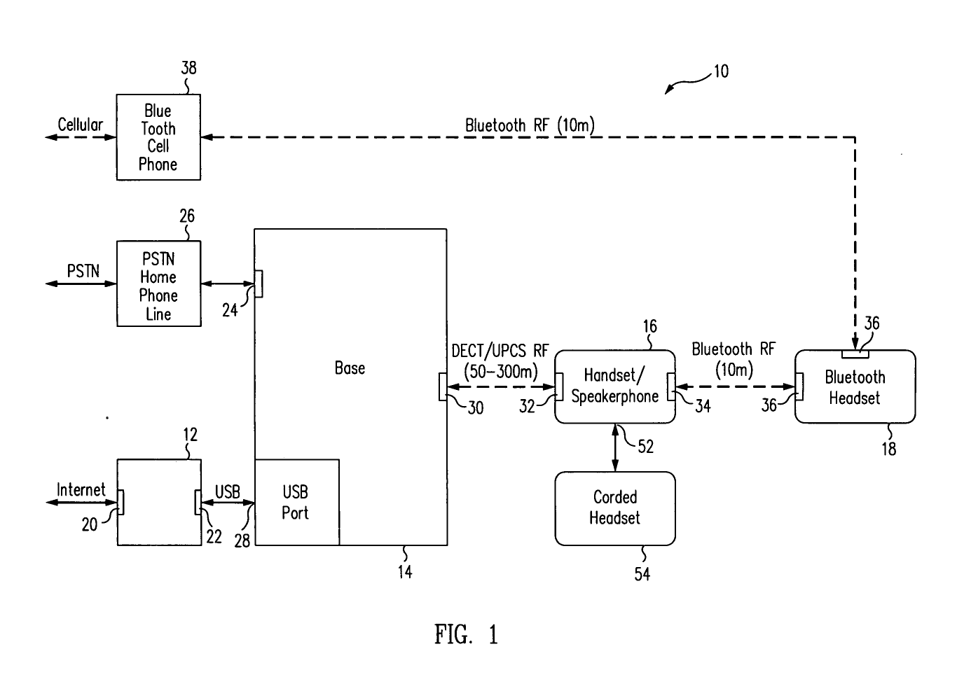

FIG. 1 is a functional block diagram of an exemplary embodiment of a wireless, multimode home telephone system 10 in accordance with the present invention. Referring to FIG. 1, the telephone system comprises four primary “hardware” components, a personal computer (PC) 12, a base 14, a wireless handset 16, and a wireless headset 18. As discussed below, the exemplary system 10 may further include an optional Bluetooth enabled cell phone 38.

Like the optional cell phone 38, the PC 12 is typically not sold with the telephone system 10, but instead, comprises a PC already owned by the user and running, e.g., a Windows, Unix, Linux or other operating system. The PC includes first and second communication ports 20 and 22. The first communication port 20 is coupled to the Internet, and the PC is programmed to implement a first communication protocol, e.g., the Voice Over Internet Protocol (VOIP), and is operable to effect full duplex voice communication via the Internet through the first port. The second port 22 implements a second communication protocol, e.g., the IEEE Universal Serial Bus (USB) protocol, and is operable to transmit and receive communication signals between the PC and the base 14 therethrough.

The base component 14 of the system 10 has a first port 24, e.g., an RJ 11 socket, coupled to a public switched telephone network (PSTN) 26 and operable to effect full duplex telecommunication via the PSTN through the first port, a second port 28, e.g., a USB port, coupled to the PC 12 via the second port 22 of the PC and operable to effect full duplex communication between and the base 14 and the PC 12 therethrough, and an RF transceiver 30 implementing a third communication protocol and operable to receive and transmit communication signals wirelessly between the base 14 and the handset 16. In the particular exemplary embodiment of FIG. 1, the third communication protocol comprises the ETSI standard, Digital Enhanced (formerly European) Cordless Telecommunications/Unlicensed Personal Communications Service (DECT/UPCS) protocol, having an effective transmission range of about 50-300 meters.

The wireless handset 16 of the system 10 incorporates first and second RF transceivers 32 and 34. The first transceiver 32 implements the third communication protocol, i.e., the DECT/UPCS protocol, and is operable to transmit and receive communication signals wirelessly between the handset 16 and the base 14. The second handset RF transceiver 34 implements a fourth communication protocol, e.g., the Bluetooth AG protocol, and is operable to transmit communication signals wirelessly between the handset 16 and the headset 18, with a range of about 10 meters.

The wireless headset 18 incorporates an RF transceiver 36 implementing the fourth communication protocol, i.e., the Bluetooth protocol, and is operable to transmit communication signals wirelessly between the headset 18 and the handset 16, and as discussed below, with an optional Bluetooth enabled cell phone 38.

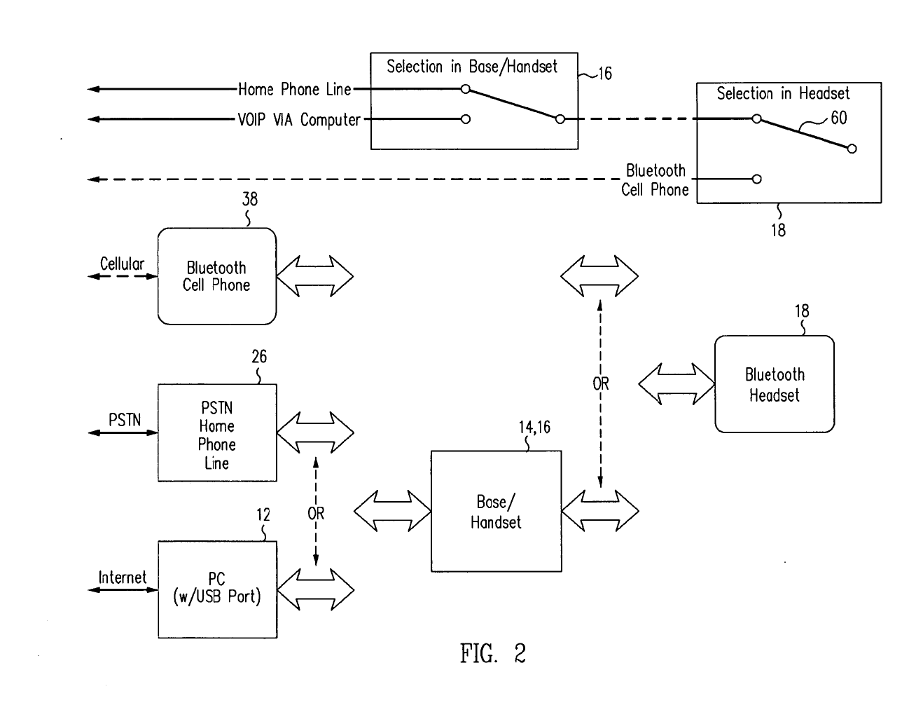

An application, such as Persono Call,™ runs on the PC and provides ringing, On hook and Off hook functions from various conventionally available “soft phone” applications. Thus, VOIP calls from, e.g., Skype (or another soft phone application) may be remotely answered by either the headset 18 or the handset 16. The handset 16 is thus able to switch between VOIP calls and PSTN calls without losing a call. In this way, the system functions as a two line telephone. Further, the headset 18 can switch between an active call selected by the handset 16 (i.e., a PSTN or a VOIP call) and a call transmitted through an optional Bluetooth enabled cell phone 38 already owned by the user by simply pressing a call select button 60 on the Bluetooth enabled headset 18, as illustrated in the call signal flow diagram of FIG. 2 and discussed below.

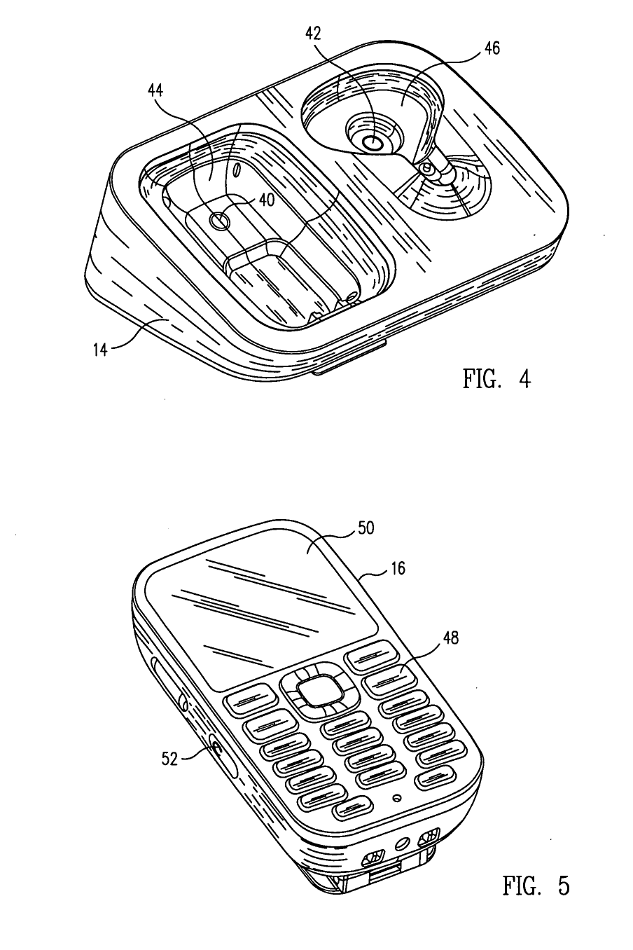

Thus, in the particular exemplary embodiment of FIG. 1, the base 14 selectably effects a connection to either the standard PSTN 26 (i.e., a common, two-wire home phone line) and a USB port 28 for connection to the PC 12 for VOIP telephony through a VOIP service (e.g., Skype, Windows Live, Vonage, or the like). The base 14, in turn, interconnects with the handset 16 via the DECT/UPCS communication protocol, and in a preferred embodiment, such as that illustrated in FIG. 4, includes handset 16 and headset 18 “Page” (i.e., finder) buttons 40 and 42, which are operable, when actuated, to cause respective ones of the handset and the headset to emit an audible signal by which they can be located.

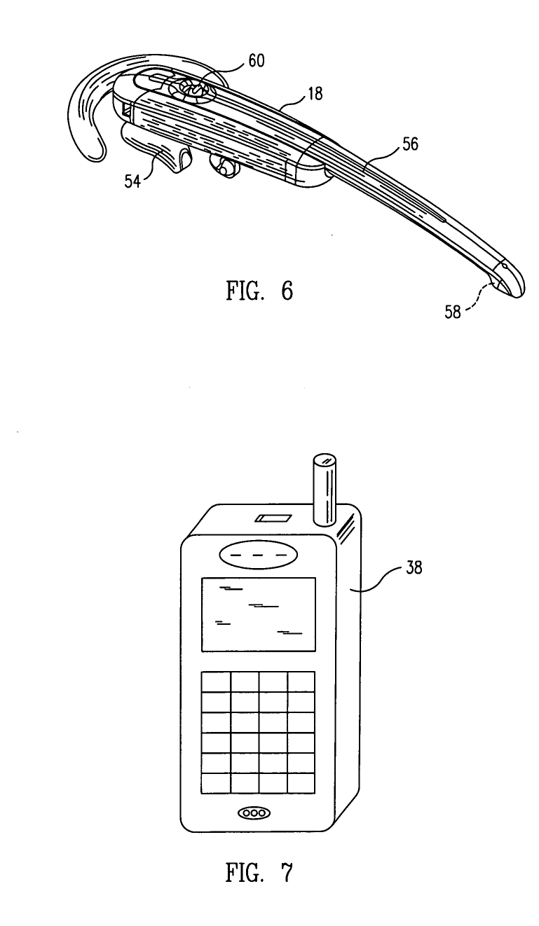

In the particular exemplary embodiment illustrated in FIG. 4, the base 14 advantageously further includes charge bays or receptacles 44 and 46 that are operable to receive respective ones of the handset 16 and the headset 18 in a cradling fashion, and to recharge the respective rechargeable batteries thereof when they are disposed in their respective receptacles. In the particular exemplary embodiment of FIG. 6, the headset 18 comprises an “over-the-ear” style of headset, and accordingly, the headset receptacle 46 of the base 14 is designed to accommodate that headset style. However, as will be appreciated by those of skill in the art, the charging receptacle 46 for the headset 18 can easily be adapted to accommodate an “over-the-head” headset design, if so desired.

The handset 16 incorporates many of the common cordless phone features, with the addition of, e.g., a half-duplex speakerphone capability, plus a Bluetooth interface for connection to the wireless Bluetooth headset 18 component of the system. The software of the handset and a simple user interface enable the selection and control of both VOIP and PSTN calls therethrough. Thus, both VOIP and PSTN audio is routed through the base 14 to the handset 16 through the DECT/UPCS RF link, and thence, via the Bluetooth RF link, to the headset 18.

The handset 16 and the headset 18 both preferably incorporate Bluetooth Applications Group (AG) firmware and hardware that support the enhanced Synchronous Communications Oriented (eSCO) protocol for communications therebetween. Additionally, the handset incorporates a half duplex speakerphone capability with competitive audio quality, and the most commonly used cordless phone handset features are made available through an intuitive, easy to use user interface (UI), e.g., “Menu Navigation” and phone book paradigms, which are designed to be similar to those of a conventional cell phone.

As illustrated in FIG. 5, in a preferred embodiment, the handset 16 further includes a dial pad 48 having a plurality of push buttons, a large, bright, back-lighted LCD display 50 and, e.g., a 2.5 mm headset jack 52 that is compatible with a conventional wired or corded headset 54 (see FIG. 1). Thus, in an “economy” embodiment, the system 10 can comprise only the base unit 14 and a handset 14 without the Bluetooth capability, and optionally, a conventional corded headset 54 that can be used with the handset via the plug-in jack 52.

As illustrated in FIG. 6, the exemplary wireless Bluetooth enabled headset 18 preferably includes an ear interface 54 that is designed for wearing comfort and based on a proven earpiece design, e.g., that of the Plantronics Explorer 320™ headset. The headset further includes a lightweight noise cancelling (NC) microphone boom 56 incorporating, e.g., a 4 mm NC microphone 58, to provide optimum transmit (TX) signal-to-noise-ratio (SNR) audio performance. The headset 18 also preferably utilizes call routing software, such as the Plantronics, Inc. Multi-Point™ software, that provides the capability to switch between two Bluetooth devices, viz., the handset 16 and the optional, conventional Bluetooth enabled cell phone 38, using a single “call select” button 60, as illustrated in FIGS. 2 and 7. Thus, the headset can switch seamlessly between the handset 16 and the conventional Bluetooth enabled cell phone 38 to both place and answer calls by simply actuating the call select button 60.

The telephone system 10 of the present invention thus provides a simple, affordable, easy to use, and versatile personal telephony system that can be used in conjunction with an existing cordless phone system, or alternatively, can be used in a standalone manner.

By now, those of skill in this art will appreciate that many modifications, substitutions and variations can be made in and to the novel telephone system of the present invention without departing from its spirit and scope. For example, two alternative embodiments of the system can be provided for the home market user, e.g., a “Lite” version and “Pro” version. The two embodiments are similar to each other, except that the Lite version would omit the computer/internet/VOIP interconnectivity for reasons of economy.

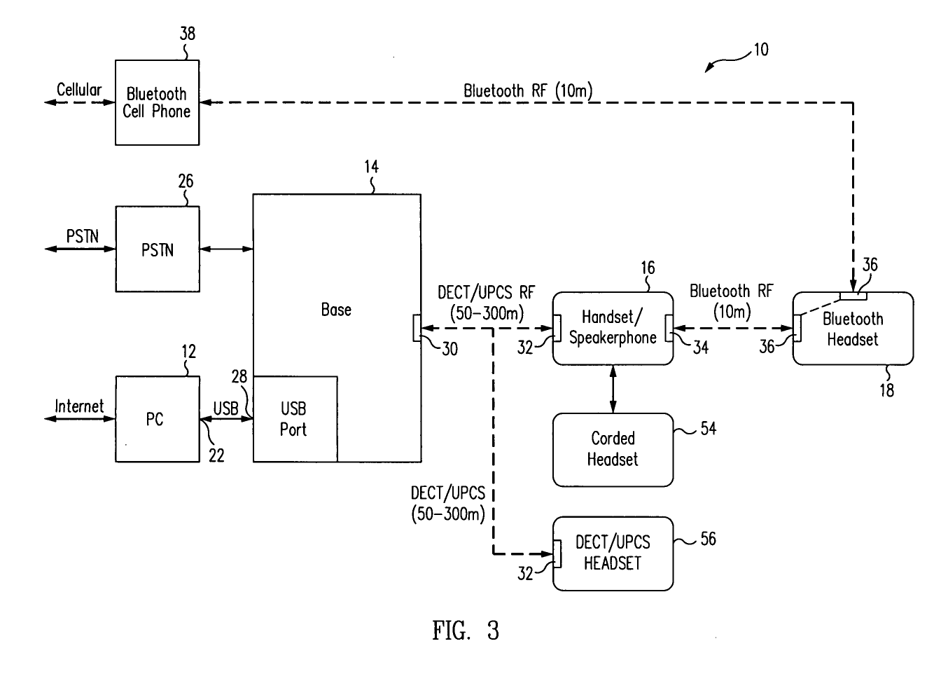

As another example of an alternative embodiment, the telephone system 10 can be configured for use with a DECT/UPCS enabled wireless headset 56 instead of, or in addition to, the Bluetooth headset 18, as shown in the alternative embodiment of the system of FIG. 3.

In light of the foregoing, the scope of the present invention should not be limited to that of the particular embodiments illustrated and described herein, as they are only exemplary in nature, but instead, should be fully commensurate with that of the claims appended hereafter and their functional equivalents.

What is claimed is:

1. A telephone system, comprising:
a personal computer (PC) having first and second communication ports, the first port being coupled to the Internet and the PC being programmed to implement a first communication protocol operable to effect full duplex communication via the Internet through the first port, the second port implementing a second communication protocol and being operable to transmit and receive communication signals to and from the PC therethrough;
a base having a first port coupled to a public switched telephone network (PSTN) and operable to effect full duplex telecommunication via the PSTN through the first port, a second port coupled to the PC via the second port of the PC and operable to effect full duplex communication between and the base and the PC therethrough, and an RF transceiver implementing a third communication protocol and operable to receive and transmit communication signals wirelessly to and from the base;
a handset having first and second RF transceivers, the first transceiver implementing the third communication protocol and operable to transmit and receive communication signals wirelessly between the handset and the base, the second RF transceiver implementing a fourth communication protocol and operable to transmit communication signals wirelessly to and from the handset; and,
a headset having an RF transceiver implementing the fourth communication protocol and operable to transmit communication signals wirelessly between the headset and the handset.

2. The system of claim 1, wherein the handset and the headset are powered by respective rechargeable batteries, and wherein the base further comprises battery charging receptacles, each of which is adapted to receive and recharge the respective battery of a respective one of the handset and the headset.

3. The telephone system of claim 1, wherein the first communication protocol comprises the Voice Over Internet Protocol (VOIP).

4. The system of claim 1, wherein the second communication protocol comprises the Universal Serial Bus (USB) protocol.

5. The system of claim 1, wherein the third communication protocol comprises the Digital Enhanced Cordless Telecommunications/Unlicensed Personal Communications Service (DECT/UPCS) protocol.

6. The system of claim 1, wherein the fourth communication protocol comprises the Bluetooth communication protocol.

7. The system of claim 1, wherein the PC further comprises software that, when executed, is operable to provide soft phone functionalities, including ringing, on hook and off hook functions.

8. The system of claim 1, wherein the base further comprises a pair of push buttons, each of which is operable, when actuated, to cause a respective one of the handset and the headset to emit an audible locating signal.

9. The system of claim 1, wherein the handset further comprises a speakerphone.

10. The system of claim 1, wherein the handset further comprises hardware for supporting an enhanced synchronous communications oriented (eSCO) protocol for wireless communication with the headset.

11. The system of claim 1, wherein the handset further comprises a jack adapted to couple a wired headset to the handset.

12. The system of claim 1, wherein the handset further comprises a dial pad having a plurality of buttons and a liquid crystal display (LCD) panel.

13. The system of claim 1, wherein the headset further comprises a microphone boom incorporating a noise cancelling (NC) microphone therein.

14. The system of claim 1, further comprising a Bluetooth enabled cell phone, and wherein the headset further comprises software that, when executed, is operable to enable the headset to select between the cell phone and the handset to place or answer a telephone call therewith.

15. The system of claim 1, wherein the handset and the handset support the enhanced Synchronous Communications Oriented (eSCO) protocol.

16. The system of claim 1, further comprising a second wireless headset having an RF transceiver implementing the third communication protocol and operable to transmit and receive communication signals wirelessly between the second headset and the base.

17. A telephone system, comprising:
a personal computer (PC) having first and second communication ports, the first port being coupled to the Internet and the PC being programmed to implement the Voice Over Internet protocol (VOIP) and operable to effect full duplex voice communication via the Internet through the first port, the second port implementing a USB communication protocol and being operable to transmit and receive telecommunication signals to and from the PC therethrough;
a base having a first port coupled to a public switched telephone network (PSTN) and operable to effect full duplex communication via the PSTN through the first port, a second port coupled to the PC via the second port of the PC and operable to effect full duplex communication between and the base and the PC therethrough, and an RF transceiver implementing the Digital Enhanced Cordless Telecommunications/Unlicensed Personal Communications Service (DECT/UPCS) communication protocol and operable to receive and transmit communication signals wirelessly to and from the base; and,
a handset having a first RF transceiver implementing the DECT/UPCS communication protocol and operable to transmit and receive communication signals wirelessly between the handset and the base.

18. The system of claim 17, wherein:
the handset further comprises a second RF transceiver implementing the Bluetooth communication protocol and operable to transmit communication signals wirelessly to and from the handset, and
the system further comprises a headset having an RF transceiver implementing the Bluetooth communication protocol and operable to transmit communication signals wirelessly between the headset and the handset.

19. The system of claim 18, further comprising a Bluetooth enabled cell phone, and wherein the headset further comprises software that, when executed, is operable to enable the headset to select between the cell phone and the handset to place or answer a telephone therewith.

20. The system of claim 18, wherein the handset further comprises a speakerphone.
